(19) United States
(12) Patent Application Publication
(10) Pub. No.: US 2023/0231792 A1
(43) Pub. Date: Jul. 20, 2023

(54) SYSTEM AND METHOD FOR MICRO TAP INSTRUCTIONS IN PACKETS IN A TELECOMMUNICATIONS NETWORK TO DIAGNOSE NETWORK ISSUES

(71) Applicant: TELUS Communications Inc., Vancouver (CA)

(72) Inventor: Ryan Hoffman, Calgary (CA)

(21) Appl. No.: 17/675,665

(22) Filed: Feb. 18, 2022

(30) Foreign Application Priority Data
Jan. 19, 2022 (CA) 3146044

(51) Int. Cl. H04L 43/10; H04L 43/50

(52) U.S. Cl. CPC H04L 43/10; H04L 43/50

(57) ABSTRACT

A method and system for routing packets in a telecommunications network includes inserting, onto a network packet at a first router, tap instructions for sending a copy of the network packet to a packet analysis resource to form a packet with tap information. A copy of the packet with tap information is received at a transit router. The transit router reads the tap instructions and causes a copy of the network packet to be sent to the packet analysis resource. The network packet is then sent to a destination within a telecommunications network.

### BACKGROUND

### Technical Field

The disclosed systems and methods relate to encoding and processing micro tap instructions in packets in a telecommunications network to diagnose network issues.

### Description of the Related Art

Telecommunication networks provide connectivity for a wide variety of digital transactions. These networks are often very large, comprised of numerous network forwarding functions, interconnected by transmission links. Monitoring the proper operation of these networks is difficult, often requiring packet analysis and diagnostic tools to troubleshoot outages or degradations due to faults.

As telecommunication networks are increasingly becoming a critical part of many aspects of our daily lives, for example, work, safety, etc., the duty of care required by network operators to deliver robust and reliable infrastructure equally increases in importance. The ability to quickly isolate network faults that interrupt connectivity of specific network services instances is a key component of network availability. As networks grow in complexity with the virtualization, public and private cloud networking, and microservices architectures, the ability to perform packet analysis at various points in the network in an agile way is extremely important.

Network operators can encounter situations where misbehaving routers in the network do not reliably transfer all packets to the destination. Packets can be discarded, or corrupted (modified) by these transit routers. It is difficult to determine which router in the path between the source and destination is the cause of this “packet mangling”, due to insufficient diagnostic counters available from transit routers. Existing software-based tap solutions from vendors do not often support the ability to classify packets with granularity in transit routers. These solutions are often limited to either physical interface-based classification, or Multiprotocol Label Switching (MPLS) label classification, which results in a large volume of copied traffic that must be tunneled to and sorted by packet analysis tools. This requires extraneous traffic capacity in the MPLS network to reach the tools edge router, and extraneous capacity in packet analysis tools.

To diagnose network impairments, network operators currently have limited options for collecting packets for analysis. To gain access to copies of network packets, either physical taps with expensive tap aggregation devices need to be deployed, or the operator must use software controls within network equipment. The high cost of physical taps prohibits their ubiquitous deployment. Where taps do not exist in the network, software controls to collect packets must be used. These controls often lack precision, requiring the collection of a large volume of superfluous packets/data, which can introduce congestion into the network if not carefully applied.

Some existing attempts at software-based tap solutions from equipment vendors are often comprised of three components: a) a classifier that determines packets of interest for analysis; b) a packet copying function that makes a duplicate copy of each packet of interest; and c) a packet tunneling function that transports the duplicate packet copies across the Internet Protocol/Multiprotocol Label Switching (IP/MPLS) network to a remote destination for analysis. Existing solutions generally embed all three of these functions in a single router. This router is typically either the source edge router or the destination edge router as these routers have existing lookup tables that can be used for matching values or patterns in header fields of subscriber packets. The transit routers existing between these source and edge routers often do not have lookup tables for useful header fields, supporting only headers that have been added by these edge routers. These transit router visible headers match a large aggregate of traffic flows, often including superfluous traffic that does not contribute and actually impedes packet analysis. Many attempts at tap solutions require the packet copy operation at the source (or ingress) MPLS router, resulting in a duplicate of each packet to be transmitted across a longer path through the network. This wastes useful transport bandwidth.

A software-based tap, mirror, or span function within network routers is an example of an attempt at this approach. This function is typically very limited in precision, resulting in additional superfluous traffic copied along with the traffic of interest, especially when this tap is applied in transit routers. While network routers vendors have attempted to improve this precision over time, a standard method to encode a right-sized field in the packet header that router hardware can match in an efficient way has not been developed. Superfluous traffic in these tapping operations has several disadvantages. It consumes network capacity unnecessarily in the path between the router copying tapped packets and the tools farm. It must be filtered out by equipment in the tools farm, to ensure accuracy in the analysis. This filtering process can be complex, or possibly technically impossible in certain circumstances. Construction of these filters takes time away from resolving the network issue, increasing the mean time to remediation/repair.

As network traffic demands continue to grow at an ever increasing rate, the aggregate volume of traffic at core network routers becomes increasingly difficult and expensive to tap. Tapping of large data flows is also a risky undertaking, with the potential to cause network congestion if not properly planned and executed. Tapping also consumes packet replication (copying) resources from network routers. These same resources can also be used for network services that require replication (e.g.: IPTV multicast, enterprise multicast VPNs). Excessive use of these resources for tap operations in an uncontrolled fashion can be service impacting.

Moreover, many existing software tap function implementations are hardware specific, which limit their use and abilities across vendors.

### BRIEF SUMMARY

In an embodiment there is provided a mechanism to precisely copy/collect only packets of interest to an operator in diagnosing impairment within a telecommunications network. By selecting only a subset of packets of interest, the volume of copied packets is deterministic. This selection also reduces the time required to analyze the collected packets, as the operator does not need to filter out the excess packets that would otherwise be captured.

There is provided in one embodiment a method of encoding tap instructions in packets in a telecommunications network. Tap instructions are inserted onto a network packet at a first router to form a packet with tap information. The tap instructions include instructions for sending a copy of the network packet to a packet analysis resource. The packet with tap information is received at a transit router. The transit router reads the tap instructions and causes a copy of the network packet to be sent to the packet analysis resource. The network packet is caused to be sent to a destination within a telecommunications network.

In various embodiments, there may be included any one or more of the following features of the method: a copy of the packet with tap information is received at a second router, the second router removes the tap instructions from the packet with tap information prior to causing the network packet to be sent to the destination within the telecommunications network; a subset of packets passing through the first router within the telecommunications network is identified to which tap instructions are to be insert onto, and the tap instructions are inserted only onto the identified subset of packets; the tap instructions include an indication to send the network packet to the packet analysis resource through a separate communication channel from a communication channel through which the network packet is sent to the destination; the transit router is configured to identify a specific communication channel associated with the tap instructions through which the copy of the network packet is to be sent to the packet analysis resource; the tap instructions are incorporated into a segment routing header of the network packet; only a single copy of the network packet is sent from the first router to the transit router; a pre-existing router in the telecommunications network is programmed to provide the functionality of the transit router; a location of the transit router is selected based at least in part on the capacity needed to tunnel traffic to the packet analysis resource from the transit router; a plurality of tap instructions are inserted onto the network packet at the first router, each of the plurality of tap instructions providing instructions to send copies of the network packet to a corresponding one of one or more packet analysis resources to form a packet with multiple tap information and a copy of the packet with multiple tap information is received at a plurality of corresponding transit routers, the corresponding plurality of transit routers each reading the corresponding tap instructions and causing a copy of the network packet to be sent to the corresponding one of the one or more packet analysis resources.

There is provided in one embodiment a system for routing packets in a telecommunications network. A first router is configured to insert onto a network packet tap instructions for sending a copy of the network packet to a packet analysis resource to form a packet with tap information. A transit router is configured to: receive a copy of the packet with tap information, read the tap instructions, and cause a copy of the network packet to be sent to the packet analysis resource. A packet analysis resource is configured to receive the copy of the network packet. A second router is configured to cause the network packet to be sent to a destination within a telecommunications network.

In various embodiments, there may be included any one or more of the following features of the system: the functions of the second router and transit router are provided by a single router; the second router is separate from the transit router, and the second router is configured to remove the tap instructions from the packet with tap information prior to causing the network packet to be sent to the destination within the telecommunications network; a subset of packets passing through the first router within the telecommunications network are identified, and in which the first router is further configured to insert the tap instructions only onto the identified subset of packets; a separate communication channel between the transit router and the packet analysis resource is separate from a communication channel through which the network packet is sent to the destination, and the tap instructions include an indication to send the network packet to the packet analysis resource through the separate communication channel; the transit router is further configured to send the copy of the network packet to the packet analysis resource through a specific communication channel associated with the tap instructions; the tap instructions are incorporated into a segment routing header of the network packet; the first router is configured to only send a single copy of the network packet to the transit router; a pre-existing router in the telecommunications network is programmed to provide the functionality of the transit router; a location of the transit router is selected based at least in part on the capacity needed to tunnel traffic to the packet analysis resource from the transit router; and the system includes one or more packet analysis resources, and a plurality of corresponding transit routers and in which the first router is further configured to insert a plurality of tap instructions onto the network packet to form a packet with multiple tap information, each of the plurality of tap instructions providing instructions to send copies of the network packet to a corresponding one of the one or more packet analysis resources, and the plurality of transit routers each receiving a copy of the packet with multiple tap information, the corresponding plurality of transit routers each being configured to read the corresponding tap instructions and cause a copy of the network packet to be sent to one of the one or more packet analysis resources.

These and other aspects of the system and method are set out in the claims, which are incorporated here by reference.

### BRIEF DESCRIPTION OF THE SEVERAL VIEWS OF THE DRAWINGS

Embodiments will now be described with reference to the figures, in which like reference characters denote like elements, by way of example, and in which:

FIG. 1 is a schematic diagram showing a segment routing network for troubleshooting traffic flow.

FIG. 2 is a flow chart showing a method of tapping packets in a telecommunications network.

FIG. 3 is a schematic diagram showing a representation of a network packet with routing and tap information.

FIG. 4 is a schematic diagram showing an exemplary segment routing network for troubleshooting traffic flow.

FIG. 5 is a schematic diagram of an exemplary source edge router.

FIG. 6 is a schematic diagram of an exemplary transit router.

FIG. 7 is a schematic diagram of exemplary segment identifiers in an exemplary network packet.

FIG. 8 is a schematic diagram of an exemplary network for the segment identifiers shown in FIG. 7.

### DETAILED DESCRIPTION

Segment routing is modern switching technology for telecommunication networks which allows for a greater degree of programmability. One of its foundational elements is the “segment”, which provides an instruction within the user plane packet for routers in these networks to execute. Multiple segments are added to the header of a user packet that enters the network, each segment providing instructions for the routers visited along the path to the packet's destination. Segments are encoded as segment identifiers or SIDs.

The majority of use cases developed for segment routing solve traffic engineering problems, where each segment provides a special forwarding instruction for routers. An adjacency segment is one example of this, where a router is instructed to send the packet out one of its specific links to an adjacent router.

Embodiments of the methods and systems herein use segment routing instructions to tap network packets. This approach may provide the ability to unify what are today uniquely implemented mirror/span/tap solutions across different vendors. Vendors use different encapsulation protocols to tunnel tapped packets. By using a standard technology, segment routing, introducing only a new instruction to this standard, vendor interoperability may be achieved.

Embodiments of the systems and method disclosed herein identify a special type of segment used for performance and packet analysis of segment routing networks. This segment is called a micro tap segment. A router that encounters a micro tap segment in its processing of the segment routing header, taps or makes a copy of the packet, and sends this copy to a destination where packet analysis can be performed.

Segment routing technology supports network programmability. The ability to automate fault isolation analysis operations with a tap instruction improves the troubleshooting time and supports self-healing networks.

Various embodiments of the methods and systems described herein support the decoupling of the classifier, the packet copying function, and the packet tunneling function from a single router. The classifier may be applied at the source edge router. The copying and tunneling functions may be applied at any transit router in the path of the packet flow. The copying and tunneling functions could also be applied at the destination edge router.

In various embodiments, the flexibility of decoupling these functions may provide the following advantages:

a. Network efficiency: the network operator can select the most optimal router for the copy function that minimizes the network capacity needed to tunnel the traffic to the packet analysis functions. This could be the transit router that is geographically closest to the tools edge router. This could also be the transit router that has a network path to the tools edge router with sufficient latent capacity to deliver the copied frames.

b. Ease of iteration: the network operator or automation software can easily reposition the micro tap SID in the segment routing header to iterate tapping through all routers in the network path. This simplifies fault isolation process and software.

c. Lower cost components: without the functionality provided in some embodiments of the methods and systems, the same precision of software tapping in transit routers would require more sophisticated forwarding chipsets, able to reach deep into network packets to match the inner payload fields that identify “interesting packets”. By using an outer header field to mark packets of interest, more shallow packet processing is required, most likely achievable in network chipsets available today.

Operations teams need to quickly resolve network issues to restore proper network operation. Embodiments of the method and system can be applied without lengthy filter construction, instead simply applying the micro tap segment into the appropriate position in the packet header to have it executed by the target network router. The network operator may choose a transit router for micro tapping based on a several criteria depending on the monitoring use case. A heavily utilized transit network might not have sufficient capacity to carry large traffic volume tapped flows. An operator would choose a transit router geographically close to the tools farm to limit the number of network links required to carry this tapped traffic for this situation. Routers will have limits for the number of concurrent micro tap sessions supported. An operator will need to choose a transit router that has not exceeded its micro tap session limit. The troubleshooting of packet mangling use case described in a later section of this document outlines how several transit routers might be iteratively chosen for micro tapping.

Embodiments disclosed herein provide for the use of segment routing SIDs for the purpose of tapping (also known as mirroring) traffic from network routers. These can be implemented on existing modern network hardware and does not require a new generation of network silicon hardware to implement. This may allow for rapid adoption and acceptance in the marketplace. This provides a method and system that can be implemented uniformly across any vendor implementing segment routing technology. Existing software tap function implementations are hardware specific and are unique in use and abilities across vendors. Embodiments of the header encapsulation selection proposed allow for header encapsulation which can be applied broadly within the networking community and is adaptable so that evolution of this header technology to support this system and method can be implement in a scalable way.

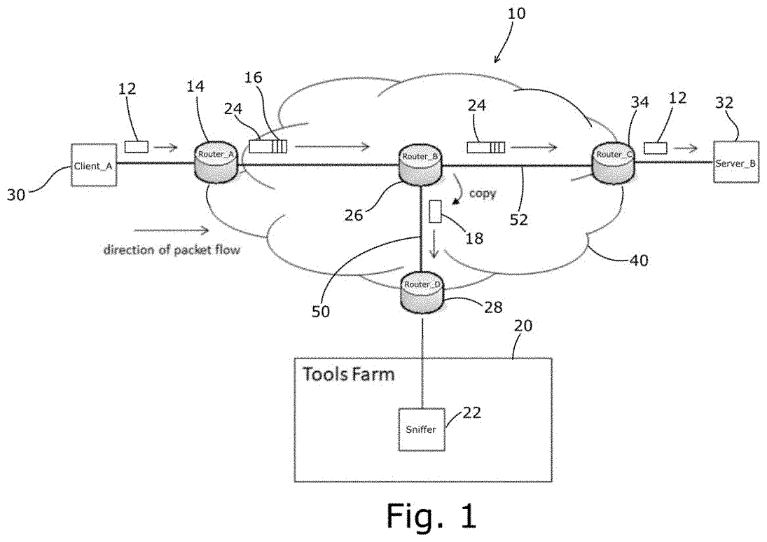

In the embodiment shown in FIG. 1, there is a system for routing network packets 12 in a telecommunications network 10. A segment routing network shown generally at 40 carries a traffic flow from a source 30, for example a host ‘Client_A’, to a destination 32, for example a server ‘Server_B’. A micro tap segment, which may be in the form of tap instructions 16, also called a ‘micro tap SID’, is inserted in a first router 14 and can be inserted along with other SIDs used for forwarding. The collection of SIDs form routing instructions which may include instructions for how the packet is to be sent to the next router and also include tap instructions on copying the packet and sending the copy to a packet analysis resource. The first router may be a source edge router, also called a first hop or head-end router. The insertion of the micro tap SID may also occur in other routers in the system. The first router 14 is configured to insert, onto a network packet 12, tap instructions for sending a copy 18 of the network packet 12 to a packet analysis resource 20. A packet with tap information 24 (FIG. 3) is formed.

A transit router 26, such as ‘Router_B’, processes the micro tap SID, sending a copy of the frame to a second destination, a packet analysis resource 20 with a “tools farm” where the network operator has packet analysis systems. The original frame then continues on to the destination server 32.

The tap instructions may be incorporated into a segment routing header 42 (FIG. 3) as one of a number of segment identifiers (SIDs). The packet analysis resource 20 may include, for example, a sniffer. Various other types of packet analysis tools may also form part of the packet analysis resource 20.

Network sniffers are expensive equipment to own, operate and distribute across a wide area of business locations. The precision provided by some embodiments of this system and method, may be extremely important in a tap service offering to a customer for privacy reasons. Embodiments of the system and method may ensure the service does not inadvertently expose the packets of one customer to another customer.

A transit router 26 receives a copy of the packet with tap information 24, reads the tap instructions 16, and causes a copy 18 of the network packet to be sent to the packet analysis resource 20. The copy 18 of the network packet may be stripped of the segment routing header 42 (FIG. 3) prior to being sent to the packet analysis resource 20. The packet analysis resource 20 is configured to receive the copy 18 of the network packet.

The first router 14 may be configured to only send a single copy of the network packet to the transit router. This helps ensure that the network is not clogged with duplicate packets.

A second router 34, which may be a destination edge router or other router, is configured to cause the network packet 12 to be sent to a destination within the telecommunications network. The network packet 12 sent to the destination may be sent to the second router 34 with the tap information, including the full segment routing header 42 (FIG. 3).

In some embodiments, the functionality of both the second router 34 and the transit router 26 may be provided by a single router. In other embodiments, the second router and transit router may be separate routers. Various routers in the system may have the functionality of the transit router 26. By having flexibility for which router may act as the transit router within the network may allow the operator to perform network diagnostics at a specific location within the network. Each of the transit routers in the network as well as the source edge router or the destination edge router may be programmed to copy packets within the network and send those packets to one or more packet analysis resources. Packet analysis resources may be placed in areas near one or more routers which function as transit routers. The placement of packet analysis resources may be chosen to minimize the geographic distance between each of the transit routers and the packet analysis resource to which that transit router is programmed to send copies of packets, while also minimizing the number of packet analysis resources employed. A single transit router may be programmed to send certain copies of packets to different packet analysis resources. By having various options for transit routers to process micro tap SIDs within the system, more accurate network analysis can be conducted without significantly increasing overall network traffic.

The second router 34 may be configured to remove the tap instructions 16 from the packet with tap information 24 prior to causing the network packet 12 to be sent to the destination 32. The packet sent to the destination may have the entire segment routing header 42 removed, including the routing and tap instructions. In the embodiment shown in FIG. 1, a network using Segment Routing version 6 (SRv6) is used where the segment routing header and all of its SIDs remain in the packet up to Router_C 34. Segment Routing MultiProtocol Label Switching (SR-MPLS) networks could support this micro tap SID as well but would remove the SID once it was processed before forwarding the frame to the end destination.

The system may select only a subset of network packets to copy using the micro tap segment. The system may identify a subset of interesting packets passing through the first router within the telecommunications network. The first router may be configured to insert the tap instructions only onto the identified subset of packets.

FIG. 3 is a representation of the packet with routing and tap information 24 including the original packet payload 12 as well as the segment routing headers 42 including the tap instructions 16 or Micro Tap SID. An example of a segment routing header is shown in more detail in FIG. 7. Packets can be classified as “packets of interest” via any one of or a combination of the following:

a) user packet header fields (e.g., 5-tuple, QoS fields, VLAN);

b) router interface(s), and more specifically ingress or egress direction on this interface;

c) packet bit patterns at a particular offset and length;

d) packet size.

The classification is performed on the source edge router 14. The packets selected with classification on this router are selected for copying in the transit router 26 based on the micro tap SID alone.

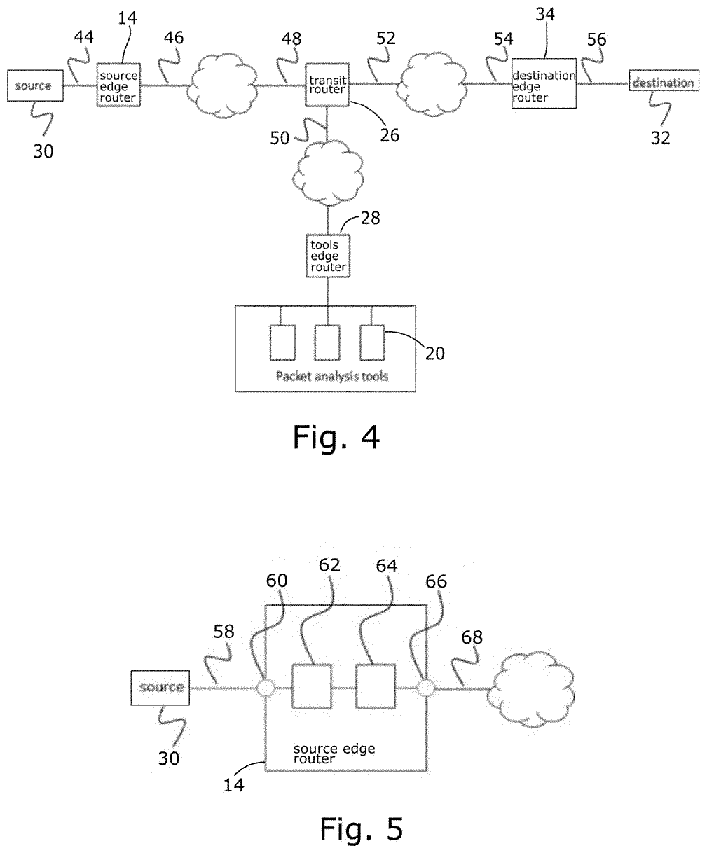

FIG. 4 provides an example IP/MPLS network that makes use of micro tap capabilities in routers. A subscriber traffic flow is initiated at the source 30 and is carried across the network to the destination 32. This flow enters the network at the source edge router 14 and exits the network at the destination edge router 34. These flows are typically Ethernet frames, that may carry IP packets as payload, and have this encapsulation carried across network links 44 and 56. If the network is MPLS, these Ethernet/IP packets are encapsulated into MPLS headers, carried across transit links 46, 48, 52 and 54. If the network is SRv6, these Ethernet/IP packets are encapsulated into SRv6 headers. Different equivalent headers may be used in different networks. The source edge router classifies packets at ingress port 44 and inserts a micro tap SID 16 (FIG. 1) into the network encapsulation used across link 46. The transit router 26 processes this micro tap SID, and performs a copy operation on the packet, sending it with a tunneling encapsulation to the packet analysis tool 20 via a tools edge router 28. There are several existing methods to tunnel these copied frames to the tools edge router which are not described in detail here. Various existing solutions can be applied. Examples of these are MPLS Pseudowire (PW), Generic Routing Encapsulation (GRE) and Layer 2 Tunneling Protocol (L2TP). The transit router also forwards the original packet on to the destination edge router via link 52.

FIG. 5 outlines the relevant subcomponents of the first router 14 for an implementation of the micro tap solution. The first router 14 may be, for example, a source edge router as shown. The router 14 will receive packets arriving from the source 30 via ingress router link 58. The operator configures the router to use the classifier component of the micro tap feature on a router interface 60. A special lookup table in the router provides this classification, including the packet characteristics that identify packets of interest for tapping, and a specific segment routing micro tap SID that should be used. Multiple concurrent micro tap sessions can be supported, with unique entries in this lookup table or classifier 62 that map to unique micro tap SIDs per session. The operator also specifies in the micro tap configuration the position within the ordered list of SIDs the micro tap SID should be placed. This position identifies which upstream segment routing router should process the micro tap SID for copy and tunneling operations. The router with the node SID in the SID list processed just before the micro tap SID is the router that will process the micro tap SID. A forwarding information base (FIB) table 64 that imposes the segment routing header onto packets will have new entries for micro tap flows, that include the micro tap SID and are used only for flows that match the classifier 62 entries. Flows with segment routing headers imposed are forwarded out of router interface 66 and are sent to the MPLS/segment routing network via link 68. This figure provides a simple high level example of how this portion of the method and system could be implemented in MPLS routers. The classifier could be implemented with less restrictions. For example, it need not be bound to a particular ingress interface but could instead support pattern matches for packets from several ingress router interfaces.

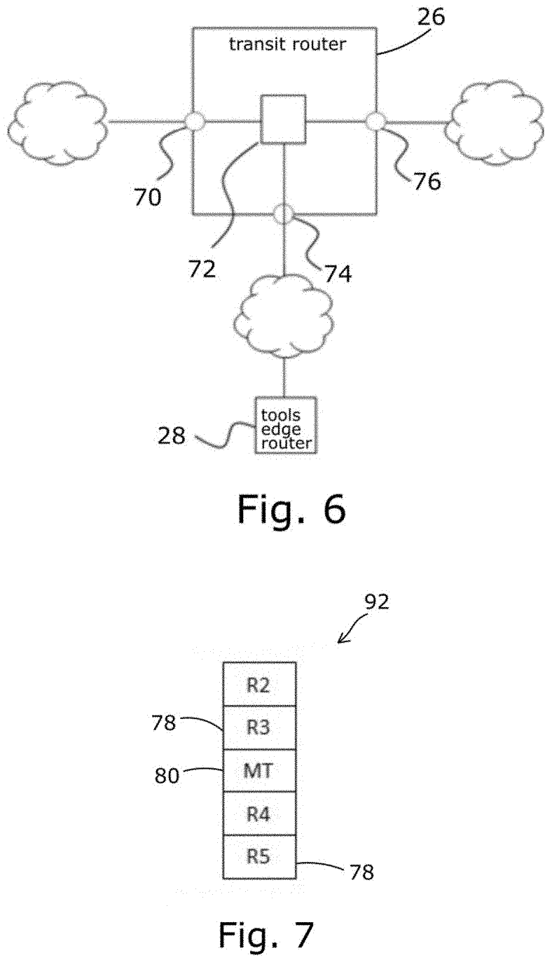

FIG. 6 outlines an example of the relevant subcomponents of the transit router 26 for an implementation of the micro tap solution. A packet with a segment routing header arrives into router interface 70. The next SID in the ordered list of SIDs in the packet header is a micro tap SID. The transit router has been preconfigured with a knowledge of the special use of this SID and has instructions in its FIB 72 for the copy and tunneling functions. The FIB 72 entries for this micro tap SID instruct the transit router to make a copy the packet and send it out a tunnel to the remote tools edge router 28. The tunnel technology should include an ability to identify a specific channel for this individual micro tap, ensuring the tools edge router and the packet analysis tools attached from it can distinguish packet flows from multiple micro tap sessions. This channel should be part of the micro tap tunnel subcomponent configuration. This tunnel may egress the transit router on a different interface 74 than the original non-copied packet that is forwarded to the destination via interface 76.

As shown in FIG. 4, a separate communication channel 50 between the transit router 26 and the packet analysis resource 20 is separate from the communication channel 52 through which the network packet is sent to the destination. The tap instructions include an indication to send the network packet to the packet analysis resource 20 through the separate communication channel 50. The transit router may be further configured to send the copy of the network packet to the packet analysis resource 20 through a specific communication channel associated with the tap instructions.

Any compatible or modifiable pre-existing router in the telecommunications network may be programmed to provide the functionality of the transit router 26. FIG. 1 shows the micro tap segment applied to packets traveling in a left to right direction (from client to server). The reverse direction of traffic can also be tapped using the same mechanism on second router 34 (Router_C) as was applied on the first router 14 (Router_A). The transit router 26 (Router_B) would apply the same copy function to this right to left flow of packets as it does for the opposing direction.

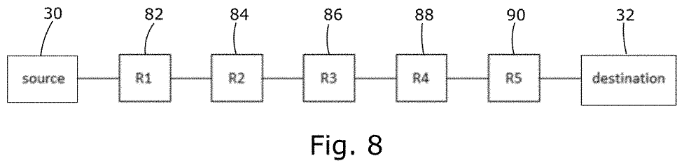

FIG. 7 provides an example of the SID List 92 found in the segment routing header applied on a source edge router 14 in the network shown in FIG. 8. This SID List, also referred to as the SID stack, is inserted into the segment routing header of the packets of interest that are tapped by the micro tap function applied in the source edge router R1. The number following the letter R in the form ‘R#’ in the entries 78 of the SID List in FIG. 7 are representations of the actual numeric values assigned as node SIDs for each router. That is, R1 corresponds to router 1 and R2 corresponds to router 2, and so on. Each SID is processed by routers in the path in top to bottom of stack order. A micro tap SID 80 is shown between the node SIDs R3 and R4.

FIG. 8 shows a sample schematic showing routers 82, 84, 86, 88, 90 labeled as routers R1 to R5, respectively. Router 86 (R3) in FIG. 8 is the transit router on which the operator wishes to perform micro tap copy and tunneling functions. The micro tap SID, indicated as 80 in FIG. 7, is placed just after the node SID for R3. This position ensures that router R3 is the router in the path that processes the micro tap SID.

This system allows the operator to choose any one of a number of pre-existing routers to be chosen as any of the first router, the second router or one or more transit routers. The decision to select specific routers to provide these functions may be made with various factors in mind, including, for example, selecting a location of the transit router based at least in part on the capacity needed to tunnel traffic to the packet analysis resource from the transit router or the router geographically closest to the tools edge router may be selected. The transit router that has a network path to the tools edge router with sufficient latent capacity to deliver the copied frames may also be selected. This transit router with the sufficient latent capacity may also be the same router that is geographically closest to the tools edge router.

A microtap system may have one or more packet analysis resources 20 (FIG. 1) and a plurality of transit routers. A first router may be configured to insert a plurality of tap instructions onto the network packet to form a packet with multiple tap information. Each of the plurality of tap instructions provide instructions to send copies of the network packet to a corresponding one of the one or more packet analysis resources, and the plurality of transit routers each receive the packet with multiple tap information, the corresponding plurality of transit routers each being configured to read their corresponding tap instruction and cause a copy of the network packet to be sent to one of the one or more packet analysis resources.

Each packet may include a payload and a header. An IP SDN controller may determine a subset of packets to have a micro tap SID incorporated at the first router 14, which is an edge IP router in this embodiment. The plurality of transit routers may each copy the packets with corresponding micro tap SIDs and send copies of the packets to the network analysis systems. The network analysis systems may be a single packet analysis resource or may be any number of packet analysis resources. In some embodiments, each transit router may be associated with a separate packet analysis resource or multiple transit routers may be associate with a single packet analysis resource. The packets will ultimately be transported through the network to the destination, such as destination 32. The telecommunications network may include a plurality of routers for transmitting packets which may or may not be programmed to provide a tapping function.

Embodiments of the system may provide tapping instructions. Each router along the path may be instructed to send a copy of the packet to the tools farm, which may be one or more sniffers 22 (FIG. 1). A tools farm could contain several generations of sniffer devices, each newer generation support higher speeds and capacity. These would be offered as a pool of resources to operations teams that manage the network. Another advantage of this method and system is the ability to make use of all these generations of sniffer devices (lowest to highest speed) due to the precision of tapping it offers. Multiple concurrent microtap sessions on the same transit router could each be tunneled to different sniffer devices.

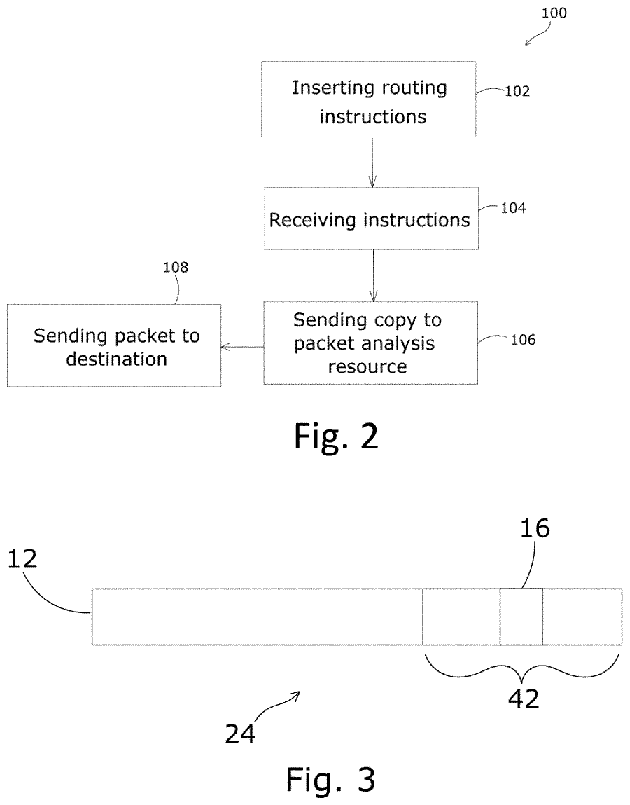

FIG. 2 shows an exemplary method 100 of tapping packets in a telecommunications network. At 102, tap instructions for sending a copy of the network packet to a packet analysis resource are inserted onto a network packet at a first router. A packet with tap information is formed. At 104, a copy of the packet with tap information is received at a transit router. The transit router reads the tap instructions and at 106 causes a copy of the network packet to be sent to the packet analysis resource. At 108, the network packet is caused to be sent to a destination within a telecommunications network.

A copy of the packet with tap information may be received at a second router. The second router may remove the tap instructions from the packet prior to causing the network packet to be sent to the destination within the telecommunications network.

The method may identify a subset of packets passing through the first router within the telecommunications network to which tap instructions are to be insert onto and insert the tap instructions only onto the identified subset of packets.

The tap instructions may include an indication to send the network packet 12 to the packet analysis resource 20 through a separate communication channel 50 from the communication channel 52 through which the network packet 12 is sent to the destination. Additionally, the transit router may be configured to identify a specific communication channel associated with the tap instructions through which the copy of the network packet is to be sent to the packet analysis resource.

The tap instructions may be incorporated into a segment routing header of the network packet. In some embodiments, only a single copy of the network packet is sent from the first router to the transit router. A pre-existing router in the telecommunications network may be programmed to provide the functionality of the transit router. A location of the transit router may be selected based at least in part on the capacity needed to tunnel traffic to the packet analysis resource from the transit router. A plurality of tap instructions may be inserted onto the network packet at the first router. Each of the plurality of tap instructions may provide instructions to send copies of the network packet to a corresponding one of one or more packet analysis resources to form a packet with multiple tap information. A plurality of corresponding transit routers may receive a copy of the packet with multiple tap information. The corresponding plurality of transit routers each may read the corresponding tap instructions and cause a copy of the network packet to be sent to the corresponding one of the one or more analysis resources.

Embodiments of the methods herein may carry out various processes using the systems described herein.

The micro tap segment function can be configured and operated in MPLS/SR routers by external network management elements, SDN (software defined networking) controllers or direct CLI (command line interface) on the router itself. Any router within the Segment Routing network capable of segment router header processing, and packet copy and encapsulation operations can be a candidate for micro tap segment function operation.

Immaterial modifications may be made to the embodiments described here without departing from what is covered by the claims. For example, each of the routers, servers or other systems disclosed may be physical, virtual, or cloud-based systems, or a combination of each of those, so long as each can implement the methods disclosed. In those cases where the systems are physical, the functionality described for each of the routers, servers, or other systems may be implemented by a single piece of hardware at a specific location or may make use of multiple systems at separate locations. The routers or servers, themselves may be provided together on a single piece of hardware or multiple pieces of hardware. The servers and routers may be of any configuration so long as they are able to carry out the methods disclosed. The network systems described may be entirely digital or analog or a mixture of the two so long as the necessary connections may be made between devices. The routers, servers or processes may be any computing device, or virtual machine, or combinations thereof, that allows for the ability to store and analyze the data required to implement one or more of the methods described herein.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method of tapping packets in a telecommunications network, the method comprising:
inserting, onto a network packet at a first router, tap instructions for sending a copy of the network packet to a packet analysis resource to form a packet with tap information;
receiving a copy of the packet with tap information at a transit router, the transit router reading the tap instructions and causing a copy of the network packet to be sent to the packet analysis resource; and
causing the network packet to be sent to a destination within a telecommunications network.

2. The method of claim 1 further comprising receiving a copy of the packet with tap information at a second router, the second router removing the tap instructions from the packet with tap information prior to causing the network packet to be sent to the destination within the telecommunications network.

3. The method of claim 1 further comprising identifying a subset of packets passing through the first router within the telecommunications network to which tap instructions are to be insert onto, and inserting the tap instructions only onto the identified subset of packets.

4. The method of claim 1 in which the tap instructions include an indication to send the network packet to the packet analysis resource through a separate communication channel from a communication channel through which the network packet is sent to the destination.

5. The method of claim 1 in which the transit router is configured to identify a specific communication channel associated with the tap instructions through which the copy of the network packet is to be sent to the packet analysis resource.

6. The method of claim 1 in which the tap instructions are incorporated into a segment routing header of the network packet.

7. The method of claim 1 in which only a single copy of the network packet is sent from the first router to the transit router.

8. The method of claim 1 in which a pre-existing router in the telecommunications network is programmed to provide the functionality of the transit router.

9. The method of claim 1 in which a location of the transit router is selected based at least in part on the capacity needed to tunnel traffic to the packet analysis resource from the transit router.

10. The method of claim 1 further comprising inserting a plurality of tap instructions onto the network packet at the first router, each of the plurality of tap instructions providing instructions to send copies of the network packet to one or more packet analysis resources to form a packet with multiple tap information and receiving a copy of the packet with multiple tap information at a plurality of corresponding transit routers, the corresponding plurality of transit routers each reading the corresponding tap instructions and causing a copy of the network packet to be sent to one of the one or more packet analysis resources.

11. A system for routing packets in a telecommunications network, the system comprising:
a first router, the first router configured to insert onto a network packet tap instructions for sending a copy of the network packet to a packet analysis resource to form a packet with tap information;
a transit router configured to:
receive a copy of the packet with tap information,
read the tap instructions, and
cause a copy of the network packet to be sent to the packet analysis resource;
a packet analysis resource configured to receive the copy of the network packet; and
a second router configured to cause the network packet to be sent to a destination within a telecommunications network.

12. The system of claim 11 in which functions of the second router and the transit router are provided by a single router.

13. The system of claim 11 in which the second router is separate from the transit router, and the second router is configured to remove the tap instructions from the packet with tap information prior to causing the network packet to be sent to the destination within the telecommunications network.

14. The system of claim 11 in which a subset of packets passing through the first router within the telecommunications network are identified, and in which the first router is further configured to insert the tap instructions only onto the identified subset of packets.

15. The system of claim 11 further comprising a separate communication channel between the transit router and the packet analysis resource being separate from a communication channel through which the network packet is sent to the destination, and the tap instructions including an indication to send the copy of the network packet to the packet analysis resource through the separate communication channel.

16. The system of claim 11 in which the transit router is further configured to send the copy of the network packet to the packet analysis resource through a specific communication channel associated with the tap instructions.

17. The system of claim 11 in which the tap instructions are incorporated into a segment routing header of the network packet.

18. The system of claim 11 in which the first router is configured to only send a single copy of the network packet to the transit router.

19. The system of claim 11 in which a pre-existing router in the telecommunications network is programmed to provide the functionality of the transit router.

20. The system of claim 11 in which a location of the transit router is selected based at least in part on the capacity needed to tunnel traffic to the packet analysis resource from the transit router.

21. The system of claim 11 further comprising:
one or more packet analysis resources, and
a plurality of corresponding transit routers;
in which the first router is further configured to insert a plurality of tap instructions onto the network packet to form a packet with multiple tap information, each of the plurality of tap instructions providing instructions to send copies of the network packet to a corresponding one of the one or more packet analysis resources, and the plurality of transit routers each receiving a copy of the packet with multiple tap information, the corresponding plurality of transit routers each being configured to read the corresponding tap instructions and cause a copy of the network packet to be sent to the corresponding one of the one or more packet analysis resources.
